(19) United States
(12) Patent Application Publication
(10) Pub. No.: US 2026/0113418 A1
(43) Pub. Date: Apr. 23, 2026

(54) ILLUMINATION SYSTEM AND PROJECTION DEVICE

(71) Applicant: Coretronic Corporation, Hsin-Chu (TW)

(72) Inventor: Pi-Tsung Hsu, Hsin-Chu (TW)

(73) Assignee: Coretronic Corporation, Hsin-Chu (TW)

(21) Appl. No.: 19/361,004

(22) Filed: Oct. 17, 2025

(30) Foreign Application Priority Data
Oct. 18, 2024 (CN) 202411458088.1

(51) Int. Cl. H04N 9/31

(52) U.S. Cl. CPC H04N 9/3114; H04N 9/3158; H04N 9/3161

(57) ABSTRACT

An illumination system including a laser light source, a wavelength conversion module, a filter module, and a condenser lens element, and a projection device are provided. The laser light source emits laser beam. The wavelength conversion module is on a transmission path of the laser beam and includes a substrate, a wavelength conversion layer, a reflective layer. The wavelength conversion layer converts the laser beam into converted beam. The converted beam includes first and second color lights having different wavebands. The reflective layer is between the wavelength conversion layer and the substrate, the reflective layer includes a reflective material and a specific light waveband absorbing material, the reflective material reflects a part of the converted beam to form reflected beam, the specific light waveband absorbing material absorbs light of a specific waveband, an absorption rate for the first color light is greater than that for the second color light.

### CROSS-REFERENCE TO RELATED APPLICATION

This application claims the priority benefit of China application serial no. 202411458088.1 filed on October 18, 2024. The entirety of the above-mentioned patent application is hereby incorporated by reference herein and made a part of this specification.

### BACKGROUND OF THE INVENTION

### FIELD OF THE INVENTION

The invention relates to an optical system and an optical device including the optical system, and in particular to an illumination system and a projection device.

### DESCRIPTION OF RELATED ART

Recently, projection devices based on solid-state light sources such as light-emitting diodes (LEDs) and laser diodes have gradually gained a place in the market. Since laser diodes have a luminous efficiency higher than LEDs by about 20%, in order to overcome the limitations of LEDs, laser light sources have been gradually developed to excite phosphors to generate the primary color light needed by projectors.

However, in general, existing projection devices are equipped with a condenser lens element, and the laser beam provided by the laser light source is condensed on the surface of the wavelength conversion layer of the phosphor wheel via the condenser lens element, thus readily causing the accumulation of heat. When the laser beam excites the phosphor wheel for a long time, deterioration or burning may occur, thus affecting the luminous efficiency and the reliability of the phosphor wheel. Therefore, in existing projection devices, the phosphor wheel is often rotated at a high speed via a driver to prevent the laser beam from staying at the same position on the phosphor wheel for too long and causing deterioration. At the same time, the heat generated by the laser beam in the phosphor wheel may be dissipated through the surface of the heat dissipation substrate and the wavelength conversion layer of the phosphor wheel via the high-speed rotation of the phosphor wheel.

However, in the existing projection device, during red light sequence, after the laser beam irradiates the wavelength conversion layer of the phosphor wheel for generating red light, an orange stimulated beam is generated. This orange stimulated beam includes yellow light having higher light intensity and red light having lower light intensity. However, when the orange stimulated beam passes through the filter wheel disposed on the rear end optical path of the phosphor wheel of the projection device, only the red light is allowed to pass through the red filter of the filter wheel, and the yellow light is reflected back to the phosphor wheel. Since the condenser lens element is usually disposed between the phosphor wheel and the filter wheel, the reflected yellow light continues to be reflected back and forth between the filter wheel, the condenser lens element, and the phosphor wheel of the projection device to generate heat. In addition, the phosphor wheel continues to generate orange light during red light sequence. Therefore, the area between the phosphor wheel and the filter wheel continues to generate and accumulate heat energy. When the projection device may not effectively dissipate heat in this area to lower temperature, the condenser lens element and the phosphor wheel are deteriorated or burnt out, thereby affecting the reliability and the service life of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

An embodiment of the disclosure provides an illumination system. An illumination system includes a laser light source, a wavelength conversion module, a filter module, and a condenser lens element. The laser light source is configured to emit a laser beam. The wavelength conversion module is disposed on a transmission path of the laser beam, and the wavelength conversion module has at least one wavelength conversion area. The wavelength conversion module includes a substrate, at least one wavelength conversion layer, and at least one reflective layer. The at least one wavelength conversion layer is disposed on the substrate and located at the at least one wavelength conversion area, and the at least one wavelength conversion layer is configured to convert the laser beam into at least one converted beam, wherein the at least one converted beam includes a first color light having a first waveband and a second color light having a second waveband. The at least one reflective layer is disposed between the at least one wavelength conversion layer and the substrate, and located at the at least one wavelength conversion area, the at least one reflective layer includes a reflective material and a specific light waveband absorbing material, and the reflective material is configured to reflect a portion of the at least one converted beam to form at least one reflected beam, the specific light waveband absorbing material is configured to absorb a light of a specific waveband, and an absorption rate for the first color light is greater than an absorption rate for the second color light. The filter module is disposed on a transmission path of the at least one reflected beam emitted from the wavelength conversion module to generate an illumination beam, wherein the filter module has at least one light filter area, and the at least one light filter area is configured to pass a light of another specific waveband in the at least one reflected beam from the wavelength conversion module to generate the illumination beam. The condenser lens element is disposed on a transmission path of the at least one reflected beam between the wavelength conversion module and the filter module.

An embodiment of the disclosure provides a projection device. The projection device includes the above illumination system, a light valve, and a projection lens. The illumination system is configured to provide an illumination beam. The light valve is located on a transmission path of the illumination beam and configured to convert the illumination beam into an image beam. The projection lens is located on a transmission path of the image beam and configured to project the image beam out of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is an architectural schematic diagram of a projection device of an embodiment of the disclosure.

FIG. 2A is a top view of the illumination system of FIG. 1.

FIG. 2B is a cross-sectional view of the illumination system of FIG. 2A.

FIG. 2C is an exploded schematic diagram of the illumination system of FIG. 2A.

FIG. 3A to FIG. 3F are cross-sectional schematic diagrams of various reflective layers of the wavelength conversion module of FIG. 2A.

FIG. 4A and FIG. 4B are reflectivity or transmittance curves of color light of different wavebands when the color light is incident on the wavelength conversion area of the wavelength conversion module of different embodiments of the disclosure.

FIG. 5A is a top view of another illumination system of FIG. 1.

FIG. 5B is an exploded schematic diagram of the illumination system of FIG. 5A.

FIG. 6A to FIG. 6C are cross-sectional schematic diagrams of various reflective layers of the wavelength conversion module of FIG. 5A.

FIG. 7A is a top view of another illumination system of FIG. 1.

FIG. 7B is an exploded schematic diagram of the illumination system of FIG. 7A.

FIG. 8A to FIG. 8C are cross-sectional schematic diagrams of various reflective layers of the wavelength conversion module of FIG. 7A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an illumination system and a projection device having good reliability.

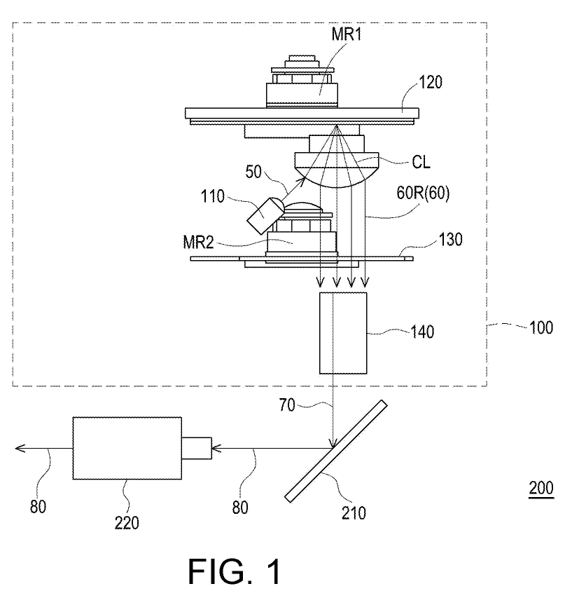

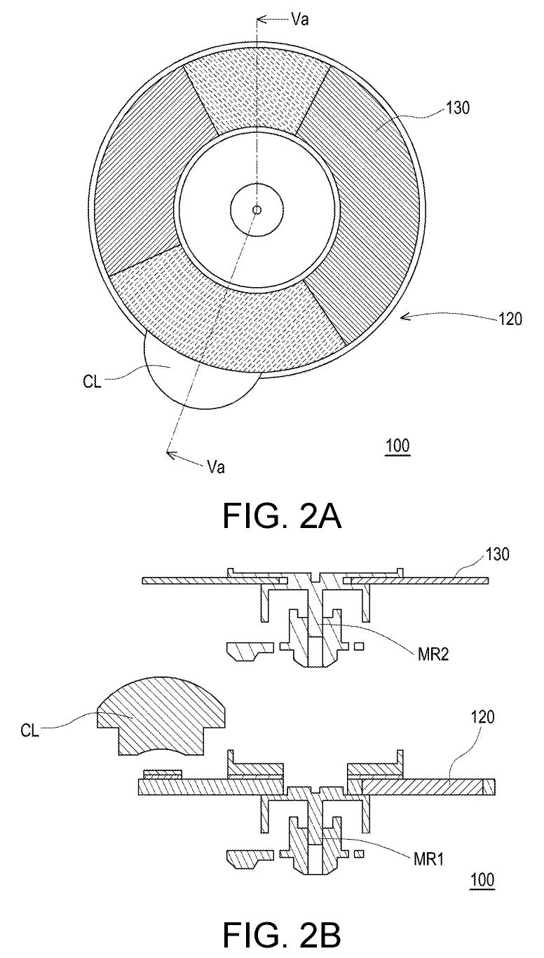

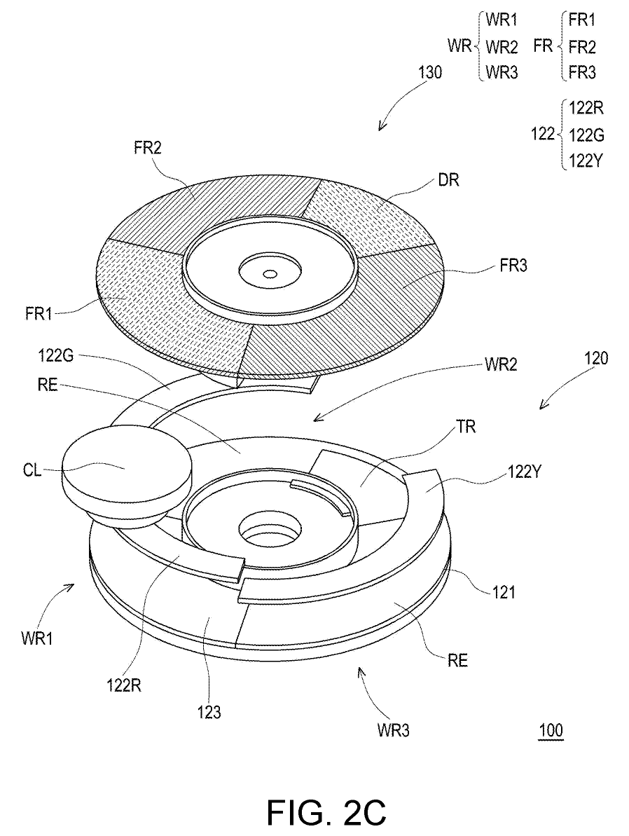

FIG. 1 is an architectural schematic diagram of a projection device of an embodiment of the disclosure. FIG. 2A is a top view of the illumination system of FIG. 1. FIG. 2B is a cross-sectional view of the illumination system of FIG. 2A. FIG. 2C is an exploded schematic diagram of the illumination system of FIG. 2A. Referring to FIG. 1 to FIG. 2C, a projection device 200 includes an illumination system 100, a light valve 210, and a projection lens 220. The illumination system 100 is configured to provide an illumination beam 70. The light valve 210 is located on the transmission path of the illumination beam 70 and configured to convert the illumination beam 70 into an image beam 80. The projection lens 220 is located on the transmission path of the image beam 80 and configured to project the image beam 80 out of the projection device 200. In the present embodiment, the light valve 210 is, for example, a digital micro-mirror device (DMD) or a liquid-crystal-on-silicon panel (LCOS panel). However, in other embodiments, the light valve 210 may also be a transmissive liquid-crystal panel or other beam modulator.

As shown in FIG. 1, in the present embodiment, the illumination system 100 includes a laser light source 110, a wavelength conversion module 120, a filter module 130, and a condenser lens element CL. The laser light source 110 is configured to emit a laser beam 50. For example, the laser light source 110 may include a plurality of blue laser diodes (not shown), and the laser beam 50 is a blue laser beam, but the invention is not limited thereto.

In FIG. 2A to FIG. 2C, the laser light source 110 is omitted for convenience of explanation. In the present embodiment, the wavelength conversion module 120 and the condenser lens element CL are disposed on the transmission path of the laser beam 50, and the wavelength conversion module 120 includes at least one wavelength conversion area WR and a non-conversion area TR. Specifically, in the present embodiment, the wavelength conversion module 120 is a phosphor wheel that may be driven by a motor MR1 to be rotated to cut the at least one of the wavelength conversion area WR and the non-conversion area TR into the transmission path of the laser beam 50 at different sequences. Furthermore, as shown in FIG. 1 to FIG. 2C, the at least one wavelength conversion area WR of the wavelength conversion module 120 is configured to convert the laser beam 50 into at least one converted beam 60 and transmitting the at least one converted beam 60 to a subsequent optical element. For example, in the present embodiment, the at least one wavelength conversion area WR of the wavelength conversion module 120 includes a first wavelength conversion area WR1, a second wavelength conversion area WR2, and a third wavelength conversion area WR3, wherein the first wavelength conversion area WR1 is, for example, a wavelength conversion area for providing red light and cut into the transmission path of the laser beam 50 at red light sequence, the second wavelength conversion area WR2 is, for example, a wavelength conversion area for providing green light and cut into the transmission path of the laser beam 50 at green light sequence, and the third wavelength conversion area WR3 is, for example, a wavelength conversion area for providing yellow light and cut into the transmission path of the laser beam 50 at yellow light sequence. However, the invention is not limited thereto. In other embodiments, the third wavelength conversion area WR3 may be omitted. Moreover, the non-conversion area TR of the wavelength conversion module 120 is a reflective area that may be configured to reflect the laser beam 50 and conduct the laser beam 50 to a subsequent optical element, but the invention is not limited thereto. In other embodiments, the non-conversion area TR may be a light-transmitting area to transmit the laser beam 50 out of the wavelength conversion module 120 to be conducted to a subsequent optical element.

Specifically, as shown in FIG. 2C, the wavelength conversion module 120 includes a substrate 121, at least one wavelength conversion layer 122, and at least one reflective layer 123. The at least one wavelength conversion layer 122 is disposed on the substrate 121 and located at the at least one wavelength conversion area WR, and the at least one wavelength conversion layer 122 is configured to convert the laser beam 50 into the at least one converted beam 60, wherein the at least one converted beam 60 includes a first color light having a first waveband and a second color light having a second waveband.

In the present embodiment, the at least one wavelength conversion layer 122 of the wavelength conversion module 120 includes a first wavelength conversion layer 122R, a second wavelength conversion layer 122G, and a third wavelength conversion layer 122Y respectively corresponding to the first wavelength conversion area WR1, the second wavelength conversion area WR2, and the third wavelength conversion area WR3. The materials of the first wavelength conversion layer 122R, the second wavelength conversion layer 122G, and the third wavelength conversion layer 122Y may be the same, such as phosphor that may be excited to emit yellow light, or, according to the requirements of providing different color light by different wavelength conversion areas WR, phosphors that may be excited to emit the desired color light may be selected as the wavelength conversion layer 122 accordingly. For example, as shown in FIG. 2C, the materials of the first wavelength conversion layer 122R and the third wavelength conversion layer 122Y located at the first wavelength conversion area WR1 and the third wavelength conversion area WR3 respectively may be phosphors that may be excited to emit yellow-orange light. In other words, the first wavelength conversion layer 122R and the third wavelength conversion layer 122Y may be excited by the laser beam 50 to generate a yellow-orange converted beam 60. The material of the second wavelength conversion layer 122G located at the second wavelength conversion area WR2 may be a phosphor that may be excited to emit yellow-green light. In other words, the second wavelength conversion layer 122G may be excited by the laser beam 50 to generate a yellow-green converted beam 60. The yellow-orange converted beam 60 generated by the first wavelength conversion layer 122R of the first wavelength conversion area WR1 includes yellow light in the middle waveband of visible light and red light in the higher waveband of visible light. The yellow-green converted beam 60 generated by the second wavelength conversion layer 122G of the second wavelength conversion area WR2 includes green light in the lower waveband of visible light and yellow light in the middle waveband of visible light.

Moreover, in the present embodiment, the reflective layer 123 is disposed between the at least one wavelength conversion layer 122 and the substrate 121 and located on the wavelength conversion area WR, such as located at the first wavelength conversion area WR1. The reflective layer 123 includes a reflective material and a specific light waveband absorbing material, and the reflective material is configured to reflect a portion of the at least one converted beam 60 to form at least one reflected beam 60R, the specific light waveband absorbing material is configured to absorb a light of a specific waveband, and the absorption rate for the first color light is greater than the absorption rate for the second color light. In the present embodiment, the specific light waveband absorbing material may be of the following types: for example, type A: compounds of transition elements such as cobalt (Co), manganese (Mn), nickel (Ni), iron (Fe), copper (Cu), etc., type B: compounds of sulfur or selenium (such as CdS, CdSe, etc.), type C: oxides in metal state (oxides of metal such as gold, silver, copper), type D: cadmium compounds (such as CdS, CdSe, CdTe, etc.) Those skilled in the art may correspondingly select specific light waveband absorbing materials in the desired light waveband according to the needs of different wavelength conversion areas WR.

For example, in the present embodiment, since the reflective layer 123 is correspondingly disposed on the first wavelength conversion area WR1 for providing red light, the first wavelength conversion layer 122R of the first wavelength conversion area WR1 is excited by the laser beam 50 to emit a yellow-orange converted beam 60. Therefore, the specific light waveband absorbing material in the reflective layer 123 may be a material for which the absorption rate for yellow light is greater than the absorption rate for red light, so that in red light sequence, at least a portion of the undesired yellow light waveband in the yellow-orange converted beam 60 is absorbed in advance. That is, in the present embodiment, the first color light is yellow light, and the second color light is red light. Moreover, in the present embodiment, a full-waveband reflection layer RE is disposed in the second wavelength conversion area WR2 and the third wavelength conversion area WR3. Different from the reflective layer 123, the full-waveband reflective layer RE is formed by a reflective material that may reflect the full-waveband of visible light, so that the yellow-green and yellow-orange converted light beams 60 generated by the second wavelength conversion layer 122G and the third wavelength conversion layer 122Y in the second wavelength conversion area WR2 and the third wavelength conversion area WR3 may be reflected by the full-waveband reflection layer RE.

The reflective layer 123 has a specific light waveband absorbing material, and the absorption rate of the specific light waveband absorbing material for the first color light is greater than the absorption rate thereof for the second color light. Therefore, when the converted beam 60 is incident on the reflective layer 123, the specific light waveband absorbing material absorbs a portion of the converted beam 60 incident on the reflective layer 123, the at least one reflected beam 60R formed by the converted beam 60 reflected by the reflective material includes a portion of the first color light and a portion of the second color light of the at least one converted beam 60, and the light intensity of the first color light in the at least one reflected beam 60R is less than the light intensity of the second color light in the at least one reflected beam 60R. For example, the light intensity of the first color light absorbed by the specific light waveband absorbing material is between 10% and 70% of the light intensity of the at least one converted beam 60 incident on the at least one reflective layer 123. In other words, via the reflective layer 123 disposed at the first wavelength conversion area WR1 for providing red light, at least a portion of the yellow light waveband in the yellow-orange converted beam 60 is absorbed by the specific light waveband absorbing material in the reflective layer 123 to reduce the accumulation of heat energy generated by the continuous transmission of this undesired yellow light waveband in a subsequent optical path, thus avoiding deterioration or burning of the condenser lens element CL and the wavelength conversion module 120, and thereby improving the reliability of the projection device 200.

Next, please refer to FIG. 1 and FIG. 2C again. The filter module 130 has at least one light filter area FR and a light dispersing area DR. The at least one light filter area FR of the filter module 130 may be configured in conjunction with the at least one wavelength conversion area WR of the wavelength conversion module 120. In the present embodiment, the light filter area FR includes three light filter areas FR 1, FR2, and FR3 respectively corresponding to the first wavelength conversion area WR1, the second wavelength conversion area WR2, and the third wavelength conversion area WR3. The light filter areas FR1, FR2, and FR3 are configured to receive the at least one reflected beam 60R and the converted beam 60 (for example, the green and yellow converted beams 60 reflected by the full-waveband reflective layer RE) from the wavelength conversion module 120 to provide purified red light, green light, and yellow light, and the light dispersing area DR is configured to pass the laser beam 50 from the non-conversion area TR to provide blue light. Specifically, in the present embodiment, the filter module 130 is a filter wheel that may be driven by a motor MR2 to be rotated, so that the sequence of the at least one light filter area FR and the light dispersing area DR corresponds to the sequence of the at least one wavelength conversion area WR and the non-conversion area TR. Furthermore, as shown in FIG. 1, in the present embodiment, the filter module 130 is disposed on the transmission path of the converted beam 60 (for example, the green and yellow converted beams 60 reflected by the full-waveband reflective layer RE) emitted from the wavelength conversion module 120 and the at least one reflected beam 60R to generate the illumination beam 70. In addition, the condenser lens element CL is disposed on the transmission path of the converted beam 60 and the at least one reflected beam 60R between the wavelength conversion module 120 and the filter module 130. Therefore, the converted beam 60 and the at least one reflected beam 60R emitted from the wavelength conversion module 120 may be incident into the filter module 130 via the condenser lens element CL. Specifically, the light filter areas FR1, FR2, and FR3 in the at least one light filter area FR may be configured to pass red light, green light, and yellow light respectively to purify red light, green light, and yellow light. The light dispersing area DR is disposed corresponding to the non-conversion area TR to pass and disperse blue light. The illumination beam 70 includes the red light, the green light, the yellow light, and the blue light purified by the filter module 130. In this way, the laser beam 50, the converted beam 60, and the reflected beam 60R may be converted into the illumination beam 70 having a plurality of different colors sequentially.

In addition, in the present embodiment, the rotation axis of the wavelength conversion module 120 and the rotation axis of the filter module 130 are coaxially disposed. However, in other embodiments, the rotation axis of the wavelength conversion module 120 and the rotation axis of the filter module 130 may be misaligned from each other rather than being on the same axis, and an optical element that may transmit the converted beam 60 and the at least one reflected beam 60R emitted from the wavelength conversion module 120 to the filter module 130 is disposed between the wavelength conversion module 120 and the filter module 130, but is not limited to the above.

Moreover, as shown in FIG. 1, in the present embodiment, the projection device 200 further includes a light uniformizing element 140 located on the transmission path of the illumination beam 70. In the present embodiment, the light uniformizing element 140 includes an integrating rod, but the invention is not limited thereto. More specifically, as shown in FIG. 1, when the illumination beam 70 is transmitted to the light uniformizing element 140 via the illumination system 100, the light uniformizing element 140 may homogenize the illumination beam 70 and transmit the illumination beam 70 to the light valve 210.

Next, as shown in FIG. 1, the light valve 210 is located on the transmission path of the illumination beam 70 and configured to convert the illumination beam 70 into the image beam 80. The projection lens 220 is located on the transmission path of the image beam 80 and configured to project the image beam 80 onto a screen (not shown) to form a projected image. Since the illumination beam 70 is transmitted to the light valve 210, the light valve 210 sequentially converts the illumination beam 70 into image beams 80 of different colors and transmits the image beams 80 to the projection lens 220. Therefore, the image beam 80 converted by the light valve 210 is projected and the projected image generated may become a color image.

In this way, the wavelength conversion module 120 may absorb the light of the specific light waveband in the reflective layer 123 of the wavelength conversion module 120 via the configuration of the specific light waveband absorbing material in the reflective layer 123 to reduce the reflection of stray light on the subsequent optical path. In this way, the reliability of the wavelength conversion module 120 and other elements of the illumination system 100 and the projection device 200 may be improved, and the conversion efficiency of the wavelength conversion module 120 may be improved at the same time, so that the illumination system 100 and the projection device 200 both have good reliability.

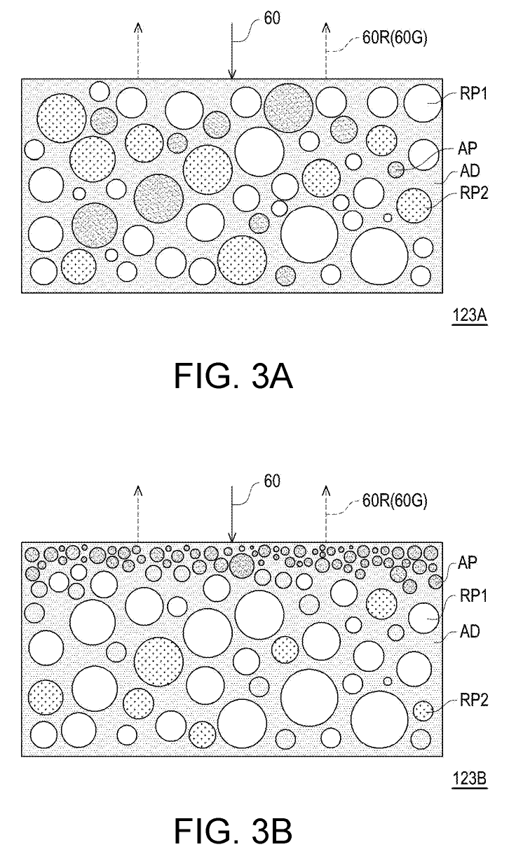

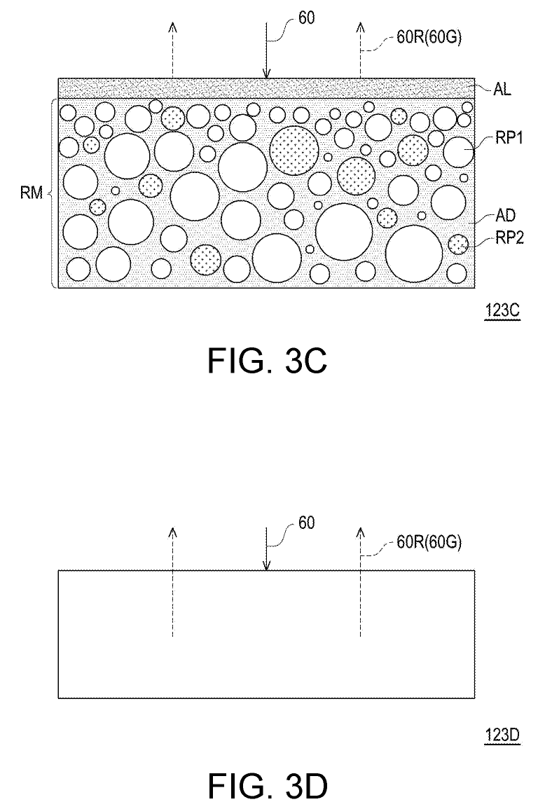

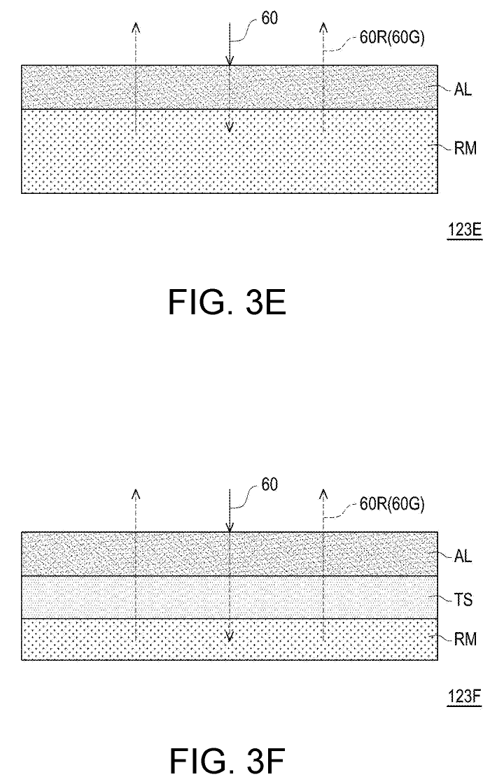

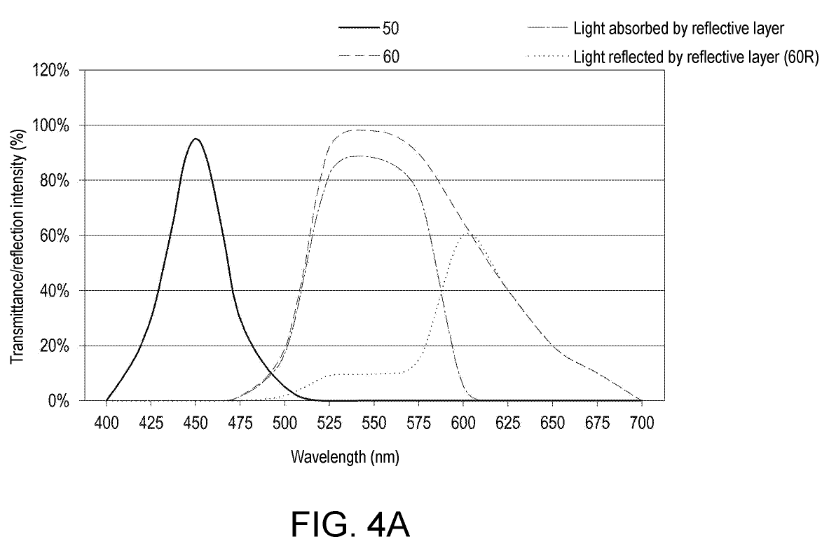

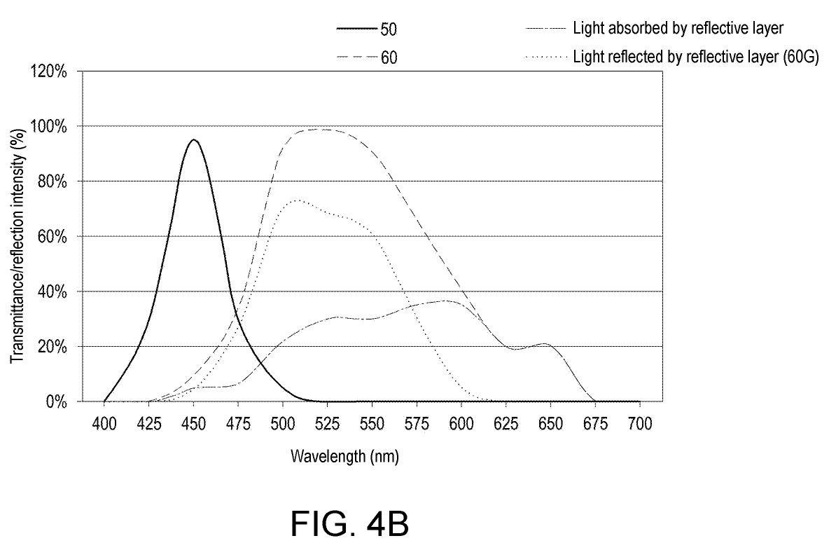

FIG. 3A to FIG. 3F are cross-sectional schematic diagrams of various reflective layers of the wavelength conversion module of FIG. 2A. FIG. 4A and FIG. 4B are reflectivity or transmittance curves of color light of different wavebands when the color light is incident on the wavelength conversion area of the wavelength conversion module 120 of different embodiments of the invention. The detailed structures of the reflective layers of various implementations of the wavelength conversion module are further explained below with reference to FIG. 3A to FIG. 3B.

In the embodiment of FIG. 3A, a reflective layer 123A includes a plurality of diffuse reflection particles RP1 and RP2 as reflective materials and a plurality of light waveband absorbing particles AP as a specific light waveband absorbing material. The plurality of diffuse reflection particles RP1 and RP2 have the property of diffusely reflecting the incident beam (for example, the conversion beam 60), and the plurality of diffuse reflection particles RP1 and RP2 and the plurality of light waveband absorbing particles AP are evenly dispersed in at least one reflection layer 123A via a bonding material AD, wherein the diffuse reflection particles RP1 and RP2 may be inhomogeneous and have different particle sizes respectively. However, in some other embodiments, the particle sizes of the diffuse reflection particles RP1 and RP2 may also be uniform, and are not limited here. In the embodiment of FIG. 3A, the particle size range of the light waveband absorbing particles AP is between 0.01 μm and 300 μm. Moreover, in the present embodiment, the volume proportion of the plurality of light waveband absorbing particles AP in the at least one reflective layer 123A is less than 30%. In this way, the specific light waveband absorbing material may control the light intensity of the first color light absorbed thereby to be between 10% and 70% of the light intensity of the at least one converted beam 60 incident on the at least one reflective layer 123A.

Moreover, for example, in the embodiment of FIG. 3A, the method of forming the reflective layer 123A on the substrate 121 may be to form a mixture of a material including the diffuse reflection particles RP1 and RP2 and the plurality of light waveband absorbing particles AP by combining the material AD and then apply the mixture on the substrate 121. Then, the material including the diffuse reflection particles RP1 and RP2 and the plurality of light waveband absorbing particles AP and the bonding material AD are cured. In addition, in some embodiments, the diffuse reflection layer 123A may also include thermally conductive particles (not shown), and the thermally conductive particles are evenly dispersed in the diffuse reflection layer 123A. For example, in the present embodiment, the diffuse reflection particles RP1 and RP2 may be particle structures formed by compounds such as titanium oxide (TiO2), aluminum oxide (Ai2O3), aluminum nitride (AlN), and the thermally conductive particles may be particle structures formed by boron nitride (BN). Furthermore, in the present embodiment, the thickness of the reflective layer 123A is between 0.03 mm and 0.25 mm.

In the embodiment of FIG. 3B, a reflective layer 123B is similar to the reflective layer 123A of FIG. 3A, and the differences between the two are as follows. In the present embodiment, the method of forming the reflective layer 123B on the substrate 121 is, for example, to first coat a mixture of a material including the diffuse reflection particles RP1 and RP2 and the bonding material AD on the substrate 121, then, a mixture including the plurality of light waveband absorbing particles AP and the bonding material AD is coated on the substrate 121, and then, the material including the diffuse reflection particles RP1 and RP2 and the plurality of light waveband absorbing particles AP and the bonding material AD are cured. In this way, as shown in FIG. 3B, the plurality of light waveband absorbing particles AP distributed in the at least one reflective layer 123B are concentrated at a side close to the surface of the at least one wavelength conversion layer 122.

In the embodiment of FIG. 3C, a reflective layer 123C is similar to the reflective layer 123A of FIG. 3A, and the differences between the two are as follows. In the present embodiment, the reflective layer 123C may include a reflective material layer RM and an absorption layer AL independent of each other. A reflective material forms the reflective material layer RM, a specific light waveband absorbing material forms the absorption layer AL, and the reflective material layer RM may be a diffuse reflection layer. Specifically, the reflective material includes the plurality of diffuse reflection particles RP1 and RP2, and the plurality of diffuse reflection particles RP1 and RP2 are evenly dispersed in the reflective material layer RM via the bonding material AD. The absorption layer AL may be a film layer or a coating layer formed by a specific light waveband absorbing material. For example, in the present embodiment, the method of forming the reflective layer 123C on the substrate 121 is, for example, to first coat a mixture of a material including the diffuse reflection particles RP1 and RP2 and the bonding material AD on the substrate 121, and then cure the material including the diffuse reflection particles RP1 and RP2 and the bonding material AD to form the reflective material layer RM. Next, the specific light waveband absorbing material is disposed on the reflective material layer RM in the form of a coating film or a coating layer. In this way, as shown in FIG. 3C, the reflective material layer RM is disposed at the substrate 121, the absorption layer AL is disposed between the reflective material layer RM and the at least one wavelength conversion layer 122, and the absorption layer AL is directly in contact with the surface of the reflective material layer RM. Since the absorption layer AL may be formed in a manner of a coating film or a coating layer, and the thickness may be between 0.002 mm and 0.05 mm, for example between 0.005 mm and 0.05 mm, the reflective layer 123C having an overall thickness that is relatively less may be formed.

In the embodiment of FIG. 3D, a reflective layer 123D has a single-layer structure. A coating film layer or a coating layer formed by a specific light waveband absorbing material and a reflective material is disposed on the substrate 121 in the form of a coating film or a coating layer, so that the reflective layer 123D is formed as a specular reflective layer having a single-layer structure. For example, in the embodiment of FIG. 3D, the reflective material may be a material such as aluminum, silver, titanium oxide, aluminum oxide.

In the embodiment of FIG. 3E, a reflective layer 123E is similar to the reflective layer 123C of FIG. 3C, and the differences between the two are as follows. In the embodiment of FIG. 3E, the reflective layer 123E may include the reflective material layer RM and the absorption layer AL independent of each other, the reflective material in the reflective material layer RM is the same as the reflective material in the embodiment of FIG. 3D, and a specular reflective layer disposed on the substrate 121 in the form of a coating film or a coating layer may be formed. In the embodiment of FIG. 3E, the thickness of the absorption layer AL may be between 0.002 mm and 0.05 mm, for example, between 0.002 mm and 0.02 mm, and the reflective layer 123E having an overall thickness that is relatively less may be formed.

In the embodiment of FIG. 3F, a reflective layer 123F is similar to the reflective layer 123E of FIG. 3E, and the differences between the two are as follows. In the embodiment of FIG. 3F, the reflective layer 123F also includes a carrier layer TS disposed between the reflective material layer RM and the absorption layer AL. In some embodiments, the arrangement of the carrier layer TS may adjust the overall thickness of the reflective layer 123F according to requirements.

In this way, since the reflective layers 123A, 123B, 123C, 123D, 123E, and 123F of FIG. 3A to FIG. 3F all have a configuration of specific light waveband absorbing materials, light of a specific light waveband may be absorbed to reduce the reflection of stray light on the subsequent optical path. In this way, the reflective layers 123A, 123B, 123C, 123D, 123E, and 123F may all be used as the reflective layer 123 of the wavelength conversion module 120 of the illumination system 100 to improve the reliability of the wavelength conversion module 120 and other elements of the illumination system 100 and the projection device 200, and improve the conversion efficiency of the wavelength conversion module 120, so that the illumination system 100 and the projection device 200 both have good reliability and achieve the above effects and advantages, which are not described again here.

Furthermore, it is worth noting that in the embodiments of FIG. 2A to FIG. 2C, although the reflective layer 123 is correspondingly disposed on the first wavelength conversion area WR1 for providing red light, and a material for which the absorption rate for yellow light greater than the absorption rate for red light is used as an example. However, the invention is not limited thereto. In other embodiments, a reflective layer 123 having other specific light waveband absorbing materials may also be disposed at the second wavelength conversion area WR2 for providing green light, so that a portion of the converted beam 60 passing through the second wavelength conversion area WR2 and incident on the reflective layer 123 is absorbed to reduce the reflection of stray light on the subsequent optical path.

As shown in FIG. 2C and FIG. 4A, when the reflective layer 123 is disposed at the first wavelength conversion area WR1 for providing red light, and the specific light waveband absorbing material in the reflective layer 123 adopts a material for which the absorption rate for yellow light is greater than the absorption rate for red light. The converted beam 60, generated after the laser beam 50 excites the first wavelength conversion layer 122R, includes yellow light having a waveband, for example, between 475 nm and 600 nm, and red light having a waveband, for example, between 600 nm and 700 nm. After the converted beam 60 is incident on the reflective layer 123, about 80% of the yellow light in the converted beam 60 is absorbed by the specific light waveband absorbing material, and the red light and the unabsorbed yellow light are reflected to form the reflected beam 60R, wherein the intensity of the red light in the reflected beam 60R accounts for approximately 60% of the intensity of the converted beam 60.

Moreover, as shown in FIG. 2C and FIG. 4B, when the reflective layer 123 is disposed at the second wavelength conversion area WR2 for providing green light, and the specific light waveband absorbing material in the reflective layer 123 adopts a material for which the absorption rate for yellow light is greater than the absorption rate for green light. The converted beam 60, generated after the laser beam 50 excites the second wavelength conversion layer 122G, includes yellow light having a waveband, for example, between 550 nm and 675 nm, and green light having a waveband, for example, between 425 nm and 550 nm. After the converted beam 60 is incident on the reflective layer 123, 30% of the yellow light in the converted beam 60 is absorbed, and the green light and the unabsorbed yellow light are reflected to form a reflected beam 60G shown in FIG. 3A to FIG. 3F, wherein the intensity of the green light of the reflected beam 60G accounts for approximately 60% to 70% of the intensity of the converted beam 60.

In this way, via the selection of different specific light waveband absorbing materials, different reflective layers 123 may be disposed for different wavelength conversion areas WR of the wavelength conversion module 120 to further reduce the reflection of stray light on the subsequent optical path.

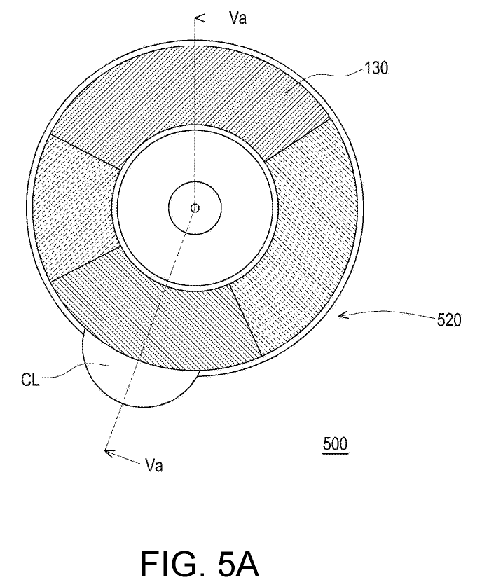

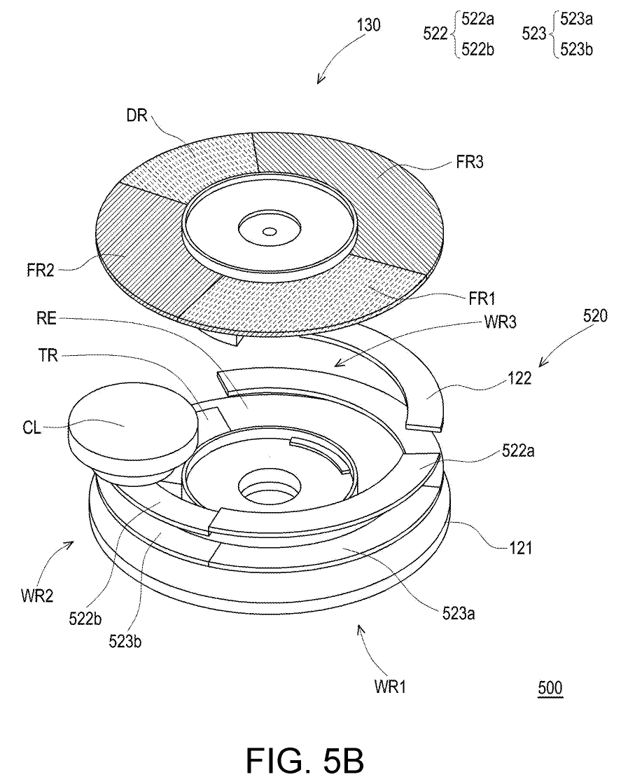

Further explanation is provided below with reference to FIG. 5A to FIG. 8C.

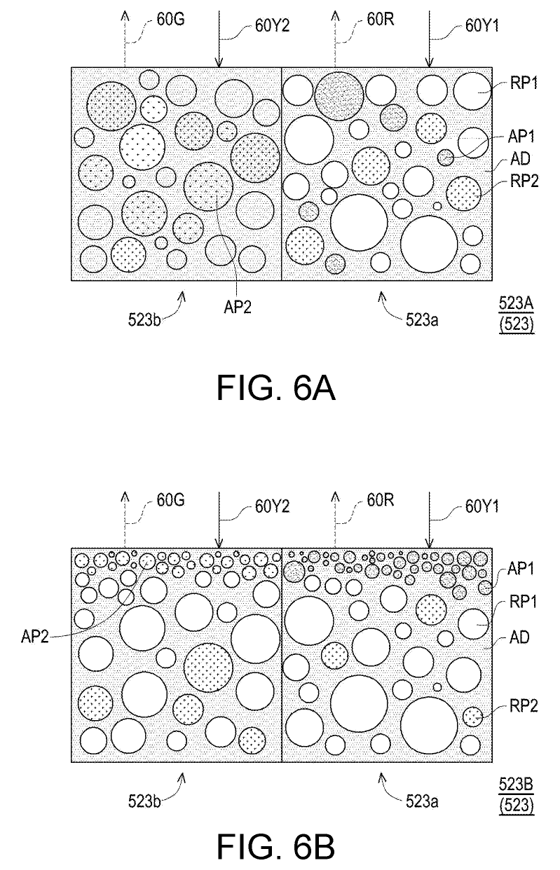

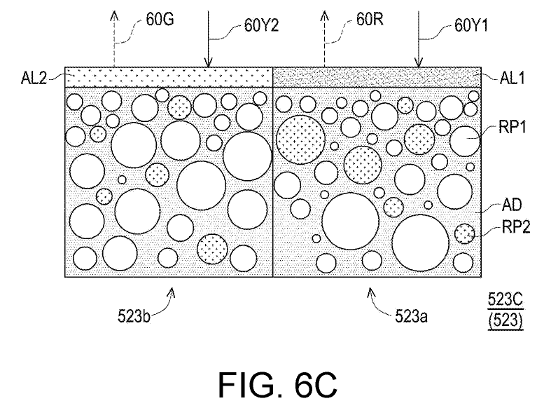

FIG. 5A is a top view of another illumination system of FIG. 1. FIG. 5B is an exploded schematic diagram of the illumination system of FIG. 5A. FIG. 6A to FIG. 6C are cross-sectional schematic diagrams of various reflective layers of the wavelength conversion module of FIG. 5A. Referring to FIG. 5A and FIG. 5B, an illumination system 500 is similar to the illumination system 100 of FIG. 2A, and the differences between the two are as follows. In the present embodiment, at least one wavelength conversion layer 522 of a wavelength conversion module 520 of the illumination system 500 includes a first wavelength conversion layer 522a and a second wavelength conversion layer 522b. The first wavelength conversion layer 522a is located at the first wavelength conversion area WR1, the second wavelength conversion layer 522b is located at the second wavelength conversion area WR2, the material of the first wavelength conversion layer 522a is a phosphor that may be excited to emit yellow-orange color light, and the material of the second wavelength conversion layer 522b is a phosphor that may be excited to emit yellow-green color light.

A first converted beam 60Y1 is generated after the laser beam 50 excites the first wavelength conversion layer 522a, the first converted beam 60Y1 includes a first color light and a second color light, a second converted beam 60Y2 is generated after the laser beam 50 excites the second wavelength conversion layer 522b, and the second converted beam 60Y2 includes a third color light having a third waveband and a fourth color light having a fourth waveband. In the present embodiment, the first color light and the third color light may be yellow light, the second color light may be red light, the fourth color light may be green light, and the second waveband is higher than the first waveband , the fourth waveband is lower than the third waveband, and the first waveband and the third waveband are at least partially overlapped. That is, in the present embodiment, the second color light is red light which has long wavelength, the fourth color light is green light which has short wavelength, and the first color light and the third color light are yellow light which has medium wavelength, and the waveband of these two are at least partially overlapped. For example, the first waveband is, for example, between 475 nm and 600 nm, the second waveband is, for example, between 600 nm and 700 nm, the third waveband is, for example, between 550 nm and 675 nm, and the fourth waveband is, for example, between 425 nm and 550 nm, but is not limited thereto.

In addition, as shown in FIG. 5B to FIG. 6C, in the present embodiment, the at least one reflective layer 523 includes a first reflective layer 523a and a second reflective layer 523b, the specific light waveband absorbing material includes a first light waveband absorbing material and a second light waveband absorbing material, the first reflective layer 523a is located at the first wavelength conversion area WR1 and disposed between the first wavelength conversion layer 522a and the substrate 121 and has a first light waveband absorbing material, the absorption rate of the first light waveband absorbing material for the first color light is greater than the absorption rate for the second color light, and the first reflective layer 523a is configured to reflect a portion of the first converted beam 60Y1 to form a first reflected beam (i.e., the reflected beam 60R). The second reflective layer 523b is located at the second wavelength conversion area WR2 and disposed between the second wavelength conversion layer 522b and the substrate 121, and has a second light waveband absorbing material. The absorption rate of the second light waveband absorbing material for the third color light is greater than the absorption rate for the fourth color light, the second reflective layer 523b is configured to reflect a portion of the second converted beam 60Y2 to form a second reflected beam (i.e., the reflected beam 60G), and at least one reflected beam includes the first reflected beam 60R and the second reflected beam 60G.

In the present embodiment, the first reflected beam 60R includes a portion of the first color light and a portion of the second color light of the first converted beam 60Y1, and the light intensity of the first color light in the first reflected beam 60R is less than the light intensity of the second color light (as shown in FIG. 4A). For example, in the present embodiment, the light intensity of the first color light absorbed by the first light waveband absorbing material is between 10% and 70% of the light intensity of the first converted beam 60Y1 incident on the first reflective layer 523a.

Moreover, in the present embodiment, the second reflected beam 60G includes a portion of a third color light and a portion of a fourth color light of the second converted beam 60Y2, and the light intensity of the third color light in the second reflected beam 60G is less than the light intensity of the fourth color light (as shown in FIG. 4B). The light intensity of the third color light absorbed by the second light waveband absorbing material is between 10% and 70% of the light intensity of the second converted beam 60Y2 incident on the second reflective layer 523b.

In this way, the wavelength conversion module 520 adopts the configuration of the first light waveband absorbing material in the first reflective layer 523a and the second light waveband absorbing material in the second reflective layer 523b, so that the light in the specific light waveband in the first converted beam 60Y1 for providing red light and the second converted beam 60Y2 for providing green light are respectively absorbed by the first reflective layer 523a and the second reflective layer 523b, and in the sequence of providing red light and green light, the reflection of stray light on the subsequent optical path may be reduced. In this way, the reliability of the wavelength conversion module 520 and other elements of the illumination system 500 may be improved, and at the same time, the conversion efficiency of the wavelength conversion module 520 may be improved, so that the illumination system 500 has good reliability to achieve similar effects and advantages as the illumination system 100, which are not described again here. When the illumination system 500 is applied to the projection device 200 instead of the illumination system 100, the projection device 200 may also achieve the above effects and advantages, which are not described again here.

The detailed structures of the first reflective layer 523a and the second reflective layer 523b of the reflective layer 523 of various embodiments of the wavelength conversion module 520 are further explained below with reference to FIG. 6A to FIG. 6C.

In the embodiment of FIG. 6A, the first reflective layer 523a and the second reflective layer 523b of a reflective layer 523A are similar to the reflective layer 123A of FIG. 3A, and the differences are as follows. Light waveband absorbing particles AP1 as the first light waveband absorbing material in the first reflective layer 523a of the reflective layer 523A adopt a material for which the absorption rate for yellow light is greater than the absorption rate for red light. Light waveband absorbing particles AP2 as the second light waveband absorbing material in the second reflective layer 523b of the reflective layer 523A adopt a material for which the absorption rate for yellow light is greater than the absorption rate for green light. Moreover, the light absorption waveband of the first light waveband absorbing material does not have to completely cover the first waveband, as long as the absorption rate of the first light waveband absorbing material for the first color light is greater than the absorption rate thereof for the second color light. In other embodiments, the light absorption waveband of the first light waveband absorbing material may cover a portion of the first waveband and a portion of the second waveband. Similarly, the light absorption waveband of the second light waveband absorbing material may cover a portion of the third waveband and a portion of the fourth waveband, but is not limited thereto.

In the embodiment of FIG. 6B, the first reflective layer 523a and the second reflective layer 523b of a reflective layer 523B are similar to the reflective layer 123B of FIG. 3B, and the differences are as follows. The light waveband absorbing particles AP1 as the first light waveband absorbing material in the first reflective layer 523a of the reflective layer 523B adopt a material for which the absorption rate for yellow light is greater than the absorption rate for red light. The light waveband absorbing particles AP2 as the second light waveband absorbing material in the second reflective layer 523b of the reflective layer 523B adopt a material for which the absorption rate for yellow light is greater than the absorption rate for green light.

In the embodiment of FIG. 6C, the first reflective layer 523a and the second reflective layer 523b of a reflective layer 523C are similar to the reflective layer 123C of FIG. 3C, and the differences are as follows. The first light waveband absorbing material of an absorption layer AL1 of the first reflective layer 523a of the reflective layer 523C adopts a material for which the absorption rate for yellow light is greater than the absorption rate for red light. The second light waveband absorbing material of an absorption layer AL2 of the second reflective layer 523b of the reflective layer 523C adopts a material for which the absorption rate for yellow light is greater than the absorption rate for green light.

Therefore, via the above configuration in which in the reflective layers 523A, 523B, and 523C of FIG. 6A to FIG. 6C, the first reflective layer 523a has the first light waveband absorbing material and the second reflective layer 523b has the second light waveband absorbing material, the first reflective layer 523a and the second reflective layer 523b of the reflective layers 523A, 523B, and 523C may respectively absorb the light of a specific light waveband in the sequence of providing red light and green light to reduce the reflection of stray light on the subsequent optical path. Therefore, the first reflective layer 523a and the second reflective layer 523b of the reflective layers 523A, 523B, and 523C may all be configured as the first reflective layer 523a and the second reflective layer 523b of the reflective layer 523 of the wavelength conversion module 520 of the illumination system 500 to improve the reliability of the wavelength conversion module 520 and other elements of the illumination system 500, and improve the conversion efficiency of the wavelength conversion module 520, so that the illumination system 500 has good reliability to achieves the above effects and advantages, which are not described again here.

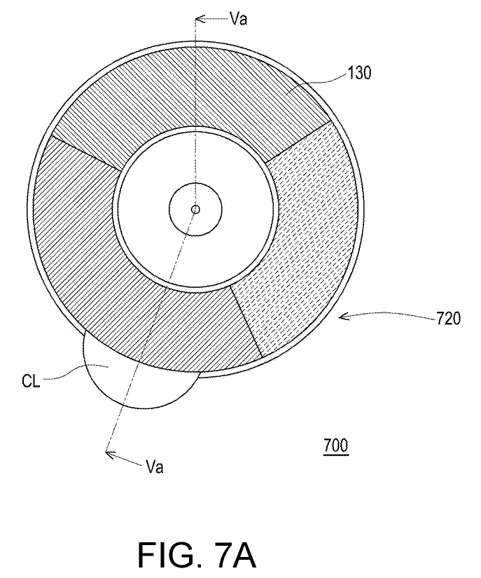

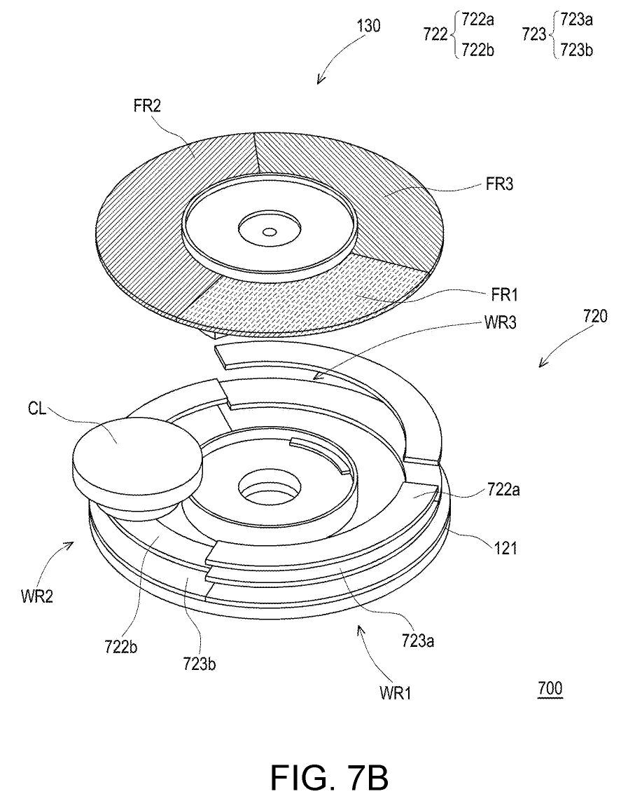

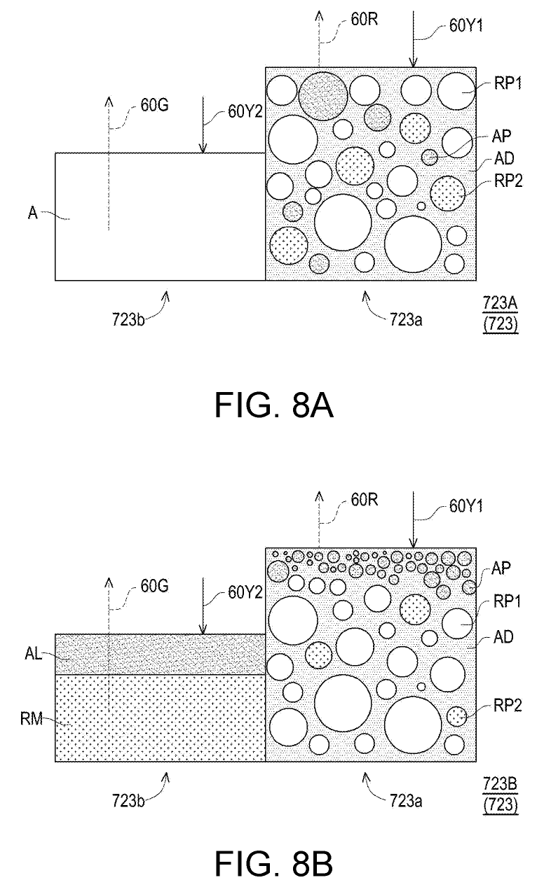

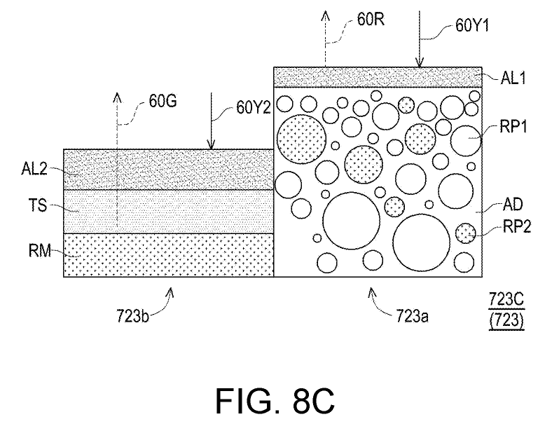

FIG. 7A is a top view of another illumination system of FIG. 1. FIG. 7B is an exploded schematic diagram of the illumination system of FIG. 7A. FIG. 8A to FIG. 8C are cross-sectional schematic diagrams of various reflective layers of the wavelength conversion module of FIG. 7A. Referring to FIG. 7A and FIG. 7B, an illumination system 700 is similar to the illumination system 500 of FIG. 5A, and the differences between the two are as follows. The illumination system 700 of FIG. 7A omits the setting of the non-conversion area TR, and, as shown in FIG. 8A to FIG. 8C, in the present embodiment, the thickness of a first reflective layer 723a and the thickness of a second reflective layer 723b of a wavelength conversion module 720 of the illumination system 700 are different.

For example, in the embodiment of FIG. 8A, the structure of the first reflective layer 723a of a reflective layer 723A is similar to that of the reflective layer 123A of FIG. 3A, the second reflective layer 723b of the reflective layer 723A has a structure similar to the reflective layer 123D of FIG. 3D, and the light waveband absorbing particles AP as the first light waveband absorbing material in the first reflective layer 723a of the reflective layer 723A adopt a material for which the absorption rate for yellow light is greater than the absorption rate for red light. The second light waveband absorbing material in the second reflective layer 723b of the reflective layer 723 adopts a material for which absorption rate for yellow light is greater than the absorption rate for green light, so that the first reflective layer 723a and the second reflective layer 723b having different thicknesses may be formed.

In the embodiment of FIG. 8B, the structure of the first reflective layer 723a of a reflective layer 723B is similar to that of the reflective layer 123B of FIG. 3B, the second reflective layer 723b of the reflective layer 723B has a structure similar to the reflective layer 123E of FIG. 3E, and the light waveband absorbing particles AP as the first light waveband absorbing material in the first reflective layer 723a of the reflective layer 723B adopt a material for which the absorption rate for yellow light is greater than the absorption rate for red light. The second light waveband absorbing material in the absorption layer AL of the second reflective layer 723b of the reflective layer 723 adopts a material for which absorption rate for yellow light is greater than the absorption rate for green light, so that the first reflective layer 723a and the second reflective layer 723b having different thicknesses may be formed.

In the embodiment of FIG. 8C, the first reflective layer 723a of a reflective layer 723C is similar to the reflective layer 123C of FIG. 3C, the second reflective layer 723b of the reflective layer 723C has a similar structure to the reflective layer 123F of FIG. 3F, and the first light waveband absorption material of the absorption layer AL1 of the first reflective layer 723a of the reflective layer 723C adopts a material for which the absorption rate for yellow light is greater than the absorption rate for red light. The second light waveband absorbing material in the absorption layer AL2 of the second reflective layer 723b of the reflective layer 723C adopts a material for which the absorption rate for yellow light is greater than the absorption rate for green light.

Therefore, via the above configuration in which in the reflective layers 723A, 723B, and 723C of FIG. 8A to FIG. 8C, the first reflective layer 723a has the first light waveband absorbing material and the second reflective layer 723b has the second light waveband absorbing material, the first reflective layer 723a and the second reflective layer 723b of the reflective layers 723A, 723B, and 723C may respectively absorb the light of a specific light waveband in the sequence of providing red light and green light to reduce the reflection of stray light on the subsequent optical path. Therefore, the first reflective layer 723a and the second reflective layer 723b of the reflective layers 723A, 723B, and 723C may all be used as the first reflective layer 723a and the second reflective layer 723b of the reflective layer 723 of the wavelength conversion module 720 of the illumination system 700 to improve the reliability of the wavelength conversion module 720 and other elements of the illumination system 700, and improve the conversion efficiency of the wavelength conversion module 720, so that the illumination system 100 has good reliability to achieves the above effects and advantages, which are not described again here. When the illumination system 700 instead of the illumination system 100 is applied to the projection device 200, the projection device 200 may also achieve the above effects and advantages, which are not described again here.

Based on the above, in the illumination system and the projection device of an embodiment of the invention, the wavelength conversion module may absorb the light of the specific light waveband in the reflective layer of the wavelength conversion module via the configuration of the specific light waveband absorbing material in the reflective layer to reduce the reflection of stray light on the subsequent optical path. In this way, the reliability of the wavelength conversion module and other elements of the illumination system and the projection device may be improved, and the conversion efficiency of the wavelength conversion module may be improved at the same time, so that the illumination system and the projection device both have good reliability.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a laser light source configured to emit a laser beam;
a wavelength conversion module disposed on a transmission path of the laser beam, wherein the wavelength conversion module has at least one wavelength conversion area, and the wavelength conversion module comprises:
a substrate;
at least one wavelength conversion layer disposed on the substrate and located at the at least one wavelength conversion area, and the at least one wavelength conversion layer is configured to convert the laser beam into at least one converted beam, wherein the at least one converted beam comprises a first color light having a first waveband and a second color light having a second waveband; and
at least one reflective layer disposed between the at least one wavelength conversion layer and the substrate and located at the at least one wavelength conversion area, the at least one reflective layer comprises a reflective material and a specific light waveband absorbing material, and the reflective material is configured to reflect a portion of the at least one converted beam to form at least one reflected beam, the specific light waveband absorbing material is configured to absorb a light of a specific waveband, and an absorption rate for the first color light is greater than an absorption rate for the second color light;
a filter module disposed on a transmission path of the at least one reflected beam emitted from the wavelength conversion module to generate an illumination beam, wherein the filter module has at least one light filter area, and the at least one light filter area is configured to pass a light of another specific waveband in the at least one reflected beam from the wavelength conversion module to generate the illumination beam; and
a condenser lens element disposed on a transmission path of the at least one reflected beam between the wavelength conversion module and the filter module.

2. The illumination system of claim 1, wherein the at least one reflected beam comprises a portion of the first color light and a portion of the second color light of the at least one converted beam, and a light intensity of the first color light in the first reflected beam is less than a light intensity of the second color light in the first reflected beam.

3. The illumination system of claim 1, wherein a light intensity of the first color light absorbed by the specific light waveband absorbing material is between 10% and 70% of a light intensity of the at least one converted beam incident on the at least one reflective layer.

4. The illumination system of claim 1, wherein the at least one wavelength conversion area comprises a first wavelength conversion area and a second wavelength conversion area, the at least one wavelength conversion layer comprises a first wavelength conversion layer and a second wavelength conversion layer, the first wavelength conversion layer is located at the first wavelength conversion area, the second wavelength conversion layer is located at the second wavelength conversion area, a first converted beam is generated after the laser beam excites the first wavelength conversion layer, the first converted beam comprises the first color light and the second color light, a second converted beam is generated after the laser beam excites the second wavelength conversion layer, and the second converted beam comprises a third color light having a third waveband and a fourth color light having a fourth waveband, and
the at least one reflective layer comprises a first reflective layer and a second reflective layer, and the specific light waveband absorbing material comprises a first light waveband absorbing material and a second light waveband absorbing material,
the first reflective layer is located at the first wavelength conversion area and has the first light waveband absorbing material, the absorption rate of the first light waveband absorbing material for the first color light is greater than the absorption rate thereof for the second color light, and the first reflective layer is configured to reflect a portion of the first converted beam to form a first reflected beam,
the second reflective layer is located at the second wavelength conversion area and has the second light waveband absorbing material, an absorption rate of the second light waveband absorbing material for the third color light is greater than an absorption rate thereof for the fourth color light, the second reflective layer is configured to reflect a portion of the second converted beam to form a second reflected beam, and the at least one reflected beam comprises the first reflected beam and the second reflected beam.

5. The illumination system of claim 4, wherein
the first reflected beam comprises a portion of the first color light and a portion of the second color light of the first converted beam, and a light intensity of the first color light in the first reflected beam is less than a light intensity of the second color light in the first reflected beam,
the second reflected beam comprises a portion of the third color light and a portion of the fourth color light of the second converted beam, and a light intensity of the third color light in the second reflected beam is less than a light intensity of the fourth color light in the second reflected beam.

6. The illumination system of claim 4, wherein the second waveband is higher than the first waveband, the fourth waveband is lower than the third waveband, and the first waveband and the third waveband are at least partially overlapped.

7. The illumination system of claim 4, wherein a light intensity of the first color light absorbed by the first light waveband absorbing material is between 10% and 70% of a light intensity of the first converted beam incident on the first reflective layer, and a light intensity of the third color light absorbed by the second light waveband absorbing material is between 10% and 70% of a light intensity of the second converted beam incident on the second reflective layer.

8. The illumination system of claim 4, wherein the first color light and the third color light are yellow lights, the second color light is a red light, and the fourth color light is a green light.

9. The illumination system of claim 4, wherein a thickness of the first reflective layer is different from a thickness of the second reflective layer.

10. The illumination system of claim 1, wherein the at least one reflective layer comprises a reflective material layer and an absorbing layer, the reflective material forms the reflective material layer, the specific light waveband absorbing material forms the absorbing layer, the reflective material layer is disposed at the substrate, the absorbing layer is disposed between the reflective material layer and the at least one wavelength conversion layer, and the absorbing layer is directly in contact with a surface of the reflective material layer.

11. The illumination system of claim 10, wherein a thickness of the absorbing layer is between and 0.002 mm and 0.05 mm.

12. The illumination system of claim 10, wherein the reflective material layer is a diffuse reflective layer, the reflective material comprises a plurality of diffuse reflection particles, and the plurality of diffuse reflection particles are evenly dispersed in the reflective material layer.

13. The illumination system of claim 10, wherein the reflective material layer is a specular reflective layer.

14. The illumination system of claim 13, wherein the at least one reflective layer further comprises a carrier layer disposed between the reflective material layer and the absorbing layer.

15. The illumination system of claim 1, wherein the reflective material comprises a plurality of diffuse reflection particles, the specific light waveband absorbing material comprises a plurality of light waveband absorbing particles, and a volume proportion of the plurality of light waveband absorbing particles in the at least one reflective layer is less than 30%.

16. The illumination system of claim 15, wherein the plurality of diffuse reflection particles and the plurality of light waveband absorbing particles are evenly dispersed in the at least one reflective layer.

17. The illumination system of claim 15, wherein the plurality of light waveband absorbing particles are distributed in the at least one reflective layer and concentrated at a side close to a surface of the at least one wavelength conversion layer.

18. The illumination system of claim 1, wherein the wavelength conversion module also comprises a non-conversion area, and the non-conversion area may be a reflective area or a light-transmitting area, the reflective area is configured to reflect the laser beam, and the light-transmitting area is configured to transmit the laser beam out of the wavelength conversion module.

19. A projection device, comprising:
an illumination system configured to provide an illumination beam, comprising:
a laser light source configured to emit a laser beam;
a wavelength conversion module disposed on a transmission path of the laser beam, wherein the wavelength conversion module has at least one wavelength conversion area, and the wavelength conversion module comprises:
a substrate;
at least one wavelength conversion layer disposed on the substrate and located at the at least one wavelength conversion area, wherein the at least one wavelength conversion layer is configured to convert the laser beam into at least one converted beam, and the at least one converted beam comprises a first color light having a first waveband and a second color light having a second waveband; and
at least one reflective layer disposed between the at least one wavelength conversion layer and the substrate and located at the at least one wavelength conversion area, wherein the at least one reflective layer comprises a reflective material and a specific light waveband absorbing material, the reflective material is configured to reflect a portion of the at least one converted beam to form at least one reflected beam, the specific light waveband absorbing material is configured to absorb a light of a specific waveband, and an absorption rate for the first color light is greater than an absorption rate for the second color light;
a filter module disposed on a transmission path of the at least one reflected beam emitted from the wavelength conversion module to generate the illumination beam, wherein the filter module has at least one light filter area, and the at least one light filter area is configured to pass a light of another specific waveband in the at least one reflected beam from the wavelength conversion module to generate the illumination beam; and
a condenser lens element disposed on a transmission path of the at least one reflected beam between the wavelength conversion module and the filter module;
a light valve located on a transmission path of the illumination beam and configured to convert the illumination beam into an image beam; and
a projection lens located on a transmission path of the image beam and configured to project the image beam out of the projection device.
